(19) United States
(12) Patent Application Publication
(10) Pub. No.: US 2005/0267821 A1
(43) Pub. Date: Dec. 1, 2005

(54) Address validation mode switch

(75) Inventor: Duane Anderson, Cockeysville, MD (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 10/845,659

(22) Filed: May 14, 2004

(51) Int. Cl. G06F 17/60

(52) U.S. Cl. 705/28

(57) ABSTRACT

A system and method for interfacing a package processing system with an address hygiene system allows selection from a plurality of address hygiene systems. In one embodiment a user can manually select either a particular hygiene system or a set of address hygiene systems. In another embodiment a particular address hygiene system or set of address hygiene systems is automatically selected based on package delivery characterization data

### FIELD OF THE INVENTION

The present invention relates generally to the field of address validation and standardization. More particularly, the invention provides a computer system and method for permitting selection of one or more address validation or standardization systems, based upon a known set of delivery characterization data.

### BACKGROUND OF THE INVENTION

The need for accurate, standardized mailing addresses is a relatively modern development. A tremendous increase in the volume of mail, mostly business mail, caused a serious crisis for the postal service in the early 1960s. The single greatest force behind the dramatic increase was the computer. The computer allowed businesses to automate a variety of mailing functions, but the postal service was not prepared for the explosion in mail volume. In response to the crisis, the Zone Improvement Plan (ZIP) was instituted. By July 1963, a five-digit ZIP code had been assigned to every deliverable address in the United States. The ZIP code marked the beginning of the modem era of address standardization.

Two decades later, the ZIP+4 code was introduced, adding a hyphen and four more digits to the ZIP code. Today, mail is sorted using multi-line optical character readers that scan the entire address, print an 11-digit Delivery Point Bar Code (DPBC) on the envelope, and sort the mail into trays in the established walk sequence along each delivery route.

Many government postal services, including the United States Postal Service (USPS), offer significantly-reduced postage rates for mailpieces bearing the ZIP+4 code or the DPBC for the destination address. Continuing advances in automation and additional discounts for pre-sorting have created an ongoing need for accurate and comprehensive address databases. The demand for addresses that are current and deliverable gave rise to complex and highly-automated systems for providing address hygiene services.

Address hygiene includes both the validation and standardization of addresses. Address validation confirms whether a given address is valid and current. Address standardization transforms a given address into the best format for meeting the guidelines established by the USPS for quality addressing. Standardization can prepare a batch of mail for pre-sorting to levels capable of earning substantial postage discounts. Standardization affects all components of the delivery address, including the format, typeface, punctuation, and ZIP code or DPBC. For example, a non-standard address such as:
John Doe
123 East Main Street, Suite A4
Atlanta, Ga. 30030
   may look quite different after standardization:
JOHN DOE
123 E MAIN ST STE A4
DECATUR GA 30030-1549

The USPS offers a variety of address databases that can be used with address hygiene systems, from basic ZIP code databases to more advanced files containing extensive detail about the more than 145 million deliverable addresses in the United States. The USPS City State file is a comprehensive list of ZIP codes with corresponding city and county names. The Five-Digit ZIP file from the USPS, when used in conjunction with the City State file, allows users to validate existing five-digit ZIP code assignments. Similarly, the ZIP+4 file provides a comprehensive list of ZIP+4 codes suitable for use with address hygiene systems. Certified software is generally required to access and use the USPS database files.

To maintain the quality and standardization of addresses, the USPS developed the Coding Accuracy Support System (CASS) for evaluating and certifying address hygiene software systems. Most users of address databases want CASS-certified software for list maintenance, mail processing, and other applications requiring accurate and standardized addressing. In order to qualify for reduced postage rates, all address lists must be periodically matched and coded to current USPS databases using CASS-certified software.

The Delivery Sequence File (DSF) is a computerized database developed by the USPS which includes a complete, standardized address for every delivery point serviced by the USPS in a discrete record. Each separate record contains the street address, the ZIP+4 code, the carrier route code, the delivery sequence number (walk sequence number), a delivery type code, and a seasonal delivery indicator. DSF includes sufficient data to accomplish address validation and standardization. DSF is offered to licensees who develop certified address hygiene software.

The USPS recently developed a new Delivery Point Validation (DPV) database to replace DSF. The DPV database is available in its basic format or in its enhanced format, called DSF², which includes additional address attributes.

USPS address databases are regularly updated with new data. In addition to periodic updates, the USPS has also developed a number of correction databases including the National Change of Address (NCOA) database containing address change records and the Locatable Address Conversion System (LACS) containing new addresses for regions that have undergone a conversion from rural route to city-type addresses. The NCOA and LACS databases represent additional steps in the address validation process.

A variety of address databases are available today, from basic ZIP code lists to sophisticated software written specifically to access the DPV and DSF² databases. The development of detailed databases is a continuing and ongoing process at the USPS and other government postal services. Additionally, the private developers of CASS-certified address hygiene software continue to develop new products for retrieving and applying the data stored in address databases.

In addition to governmental postal services, private commercial carriers such as UPS develop and maintain address databases for storing unique and valuable customer information. Private databases, developed independent of postal service data, represent the next generation in addressing precision and data storage. In the future, a variety of governmental and private address databases will be available.

Commercial carriers also have address standardization requirements that are different from the USPS quality addressing guidelines. In many cases, commercial carriers have developed many additional fields of data accompanying a normal street address which provide more detail, special instructions, contact information, and other desirable attributes connected to a destination address. The kind of data surrounding a particular address is growing and changing.

The increasing variety of address databases, as well as the variety of address data available, creates a dilemma for all types of users, from letter and parcel mailers to address hygiene software developers. In an environment with different types of users requiring different levels or types of address hygiene, access to a single address checking process is insufficient for all types of applications. Thus, there is a need for a method and system for enabling selection of an appropriate address database for validating or standardizing an address.

### SUMMARY OF THE INVENTION

The present invention seeks to provide an improved computer system and method for interfacing a package processing system with an address hygiene system.

In accordance with the invention, this object is accomplished by providing a system and method that allows a package sender to select one or more address hygiene systems by displaying a menu of available hygiene systems and receiving input designating one or more of the hygiene systems. The object of the invention is further accomplished in another embodiment by providing a system and method for automatically selecting one or more address hygiene systems based upon delivery characterization data entered by the package sender.

Preferably, the invention is accomplished through the use of a system comprising an internet accessible computer system linked to remote computer software programmed to perform the above mentioned objects of the invention. The invention also encompasses the concept of sending the delivery characterization data to the manually or automatically selected hygiene systems and receiving back address information. When automatically selecting one or more address hygiene systems, the system or method can also give the package sender the option of either using the automatically selected hygiene systems or selecting different hygiene systems.

Other objects, features, and advantages of the present invention will become apparent upon reviewing the following detailed description of preferred embodiments of the invention, when taken in conjunction with the drawings and the appended claims.

### BRIEF DESCRIPTION OF THE DRAWINGS

Having thus described the invention in general terms, reference will now be made to the accompanying drawings, which are not necessarily drawn to scale, and wherein:

FIG. 1 is generally illustrative of a package shipping system in which the present invention can be utilized.

FIG. 2 is a block diagram of a system for interfacing a package processing system with an address hygiene system according to one embodiment of the invention.

FIG. 3 is a block diagram illustrating various functions of a user interface system embodying the invention.

FIG. 4 is a flow chart describing operation of the user interface system main module employed in an embodiment of the present invention.

FIG. 5 is a flow chart describing operation of the select address hygiene system module employed in an embodiment of the present invention.

FIG. 6 is a flow chart describing operation of the select address hygiene system module employed in an alternative embodiment of the present invention.

### DETAILED DESCRIPTION OF THE DISCLOSED EMBODIMENTS

### Illustrative Environment

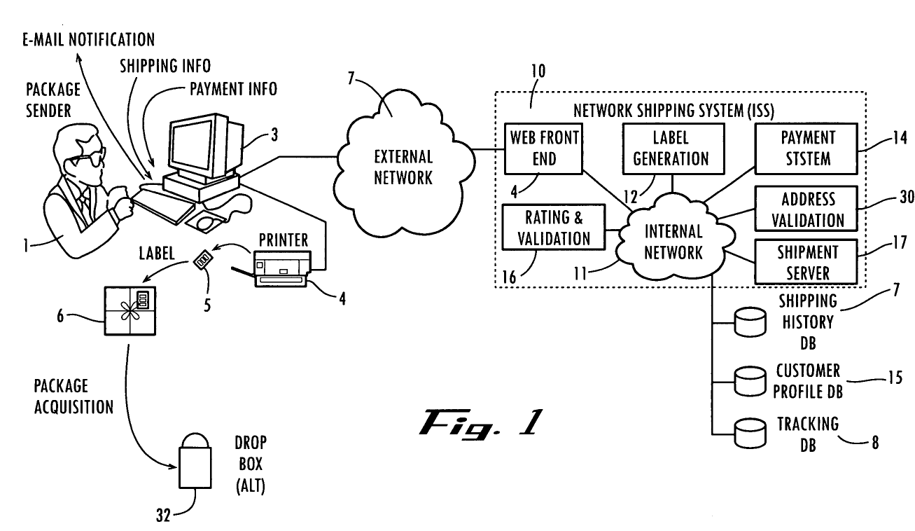

By way of introduction, FIG. 1 diagrammatically represents one example of a system in which the present invention can be utilized. One skilled in the art will understand from the following description that the interface provided by the present invention can be located along with an application program that uses address information and an address hygiene system on a single computer. Many other systems can utilize the present invention, such as carrier sorting systems, mailing list generators, direct mail systems, and online shopping systems.

FIG. 1 pictorially represents a system in which a package sender 1 utilizes a network accessible computer or computer-based workstation 3 to communicate with an Shipping System (ISS) 10, which is operated by a shipping service provider (SSP), to provide information and a label required for shipping a package. A similar ISS is described in WIPO Publication WO 00/46728, published Aug. 10, 2000.

In order to communicate with the ISS 10, the package sender 1 employs a computer or computer-based work station 3, to which is connected one or more peripherals that permit interface with the package sender 1. For example, connected to the computer 3 in this embodiment is a video monitor, a pointing device such as a mouse, and a data entry device such as a keyboard. Also connected to the computer is a printer 4. The printer is operative in the usual manner to print a label 5 for affixing to the package 6. These peripherals are connected to the computer 3 in a manner well known to those skilled in the art.

The computer 3 is connected to an external network 7, preferably a global communication network such as the Internet, to which the shipping service provider (SSP) is also connected. The term “communication network” is used expansively herein to include a local area network (LAN), a geographically dispersed wide area network (WAN) such as an enterprise-wide computer network, a public switched network (PSN) such as a telephone system, a linked cellular system, a wireless data network, other types of networks, or combinations of various computer networking technologies. The illustrated embodiment employs the Internet 7. It will therefore be understood that when the terms “network” or “Internet” are used herein, other types of computer and communications networks are also contemplated and considered equivalent.

Although the preferred embodiment is described in connection with a personal computer 3 that is operative with an Internet browser computer program, it should be understood that the invention may be implemented with other types of networked devices, for example but not of limitation, an “Internet Shipping Terminal” (IST), a web phone type device, a web TV device, a label printer, and other types of data processing and printing devices which can be coupled to a computer communication network, wired or wireless.

Generally speaking, a package sender 1 can ship a package 6 from one location to a recipient at a different location by employing the services of a SSP that operates the system 10 and carries out the various methods described herein.

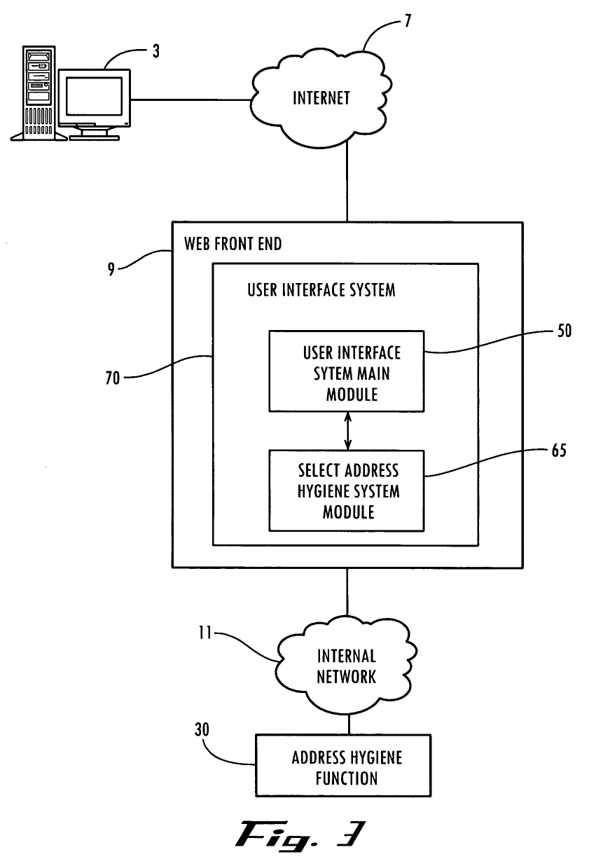

Still referring to FIG. 1, the ISS 10 provides many functions and processes to enable a package sender 1 to efficiently send a package 6. These functions are typically implemented as routines, processes, and database searches within the ISS 10 and systems coupled for communications to the ISS, e.g. a shipping history database 7 or a tracking database 8. In particular, a preferred embodiment provides an Internet World Wide Web (WWW) front end 9 that generates browser views for display on the package sender's computer 3. The web front end 9 is coupled to an internal network 11 operated by the SSP, which is coupled to other computing functions as described below. In one embodiment of the present invention, a user interface system 70, shown in FIG. 3, is located on the web front end 9 and generates the browser views for display on the package sender's computer 3.

A label generation function 12 is provided for communicating print label indicia to the package sender's computer 3 in response to acceptance of a shipping order from the customer. The label generation function 12 causes the customer's computer 3 to display a customized label image containing certain machine-readable and human-readable information needed for processing and shipping the package. If acceptable by the sender, the sender prints the displayed label 5 at the printer 4.

A payment system 14 provides for processing payment instructions and collecting payment from the customer by charging a valid credit card account, or charging the customer's pre-established SSP account. In another embodiment, payment authorization may be performed by the payment system 14 and actual charging to an account may be performed by a billing system (not shown).

A customer profile database 15 stores information associated with each customer such as their identity, location, default method of payment and preferred shipment delivery type or method.

An address hygiene function 30 receives address information from the customer and determines whether the address of the intended recipient is valid. The address hygiene system 30 may include a plurality of systems including address validation systems, address standardization systems or other address hygiene systems.

A shipping history database 7 stores information regarding each customer's prior shipments and makes that information available to the customer upon the customer's request. A record of prior shipments may be maintained for whatever length of time is desirable to the SSP.

A tracking database 8 stores information regarding each customer's current shipment, such as the present location and expected delivery time, and makes that information available upon the customer's request. Tracking is achieved, as well known by those skilled in the art, by scanning and otherwise capturing identification indicia on each package to identify the location of the package, and by communicating that location to the user upon request.

A rating and validation engine (RAVE) function 16 is operative to process information about the delivery order and determine the shipping rate based on the selected delivery options.

A shipment server 17 receives information regarding an order and communicates package pickup information to an on demand system (not shown) which may dispatch an employee to pick up a package for delivery.

The various functions of the ISS 10 cooperate to provide the functions of receiving a customer order via the Internet 7, processing the order to determine order acceptability, obtaining payment for the level of service requested, transmitting print label information to the customer's computer 3 so that a shipping label 5 may be printed from the printer 4, generating a pickup order for the package, receiving status information from other components within the SSP's system so that the package may be tracked, and creating a shipping history associated with each customer. The present invention is associated with and can be utilized within the address hygiene function 30. Further details of the address hygiene function 30 are provided below.

### Address Hygiene Architecture

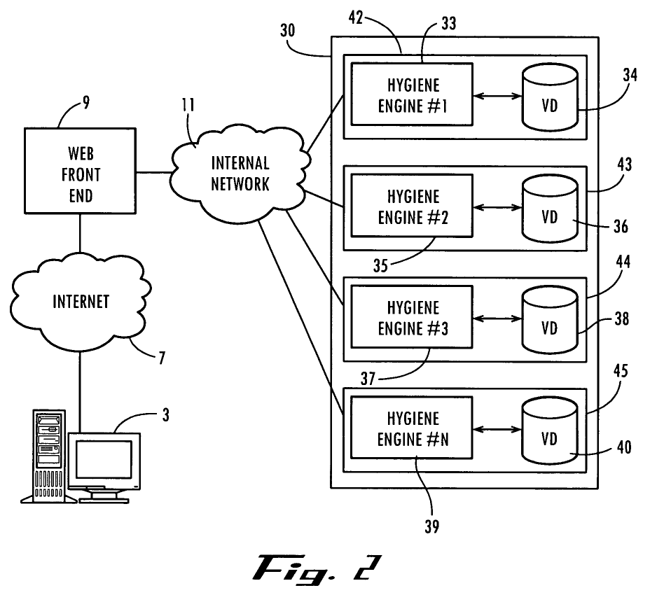

FIG. 2 represents in more detail relevant parts of a system in which the present invention can be utilized. FIG. 2 pictorially represents a network accessible computer or computer-based workstation 3 in communication with a web front end 9 for the purpose of validating or updating an address. In FIG. 2, the illustrated embodiment employs the Internet 7 to connect the network accessible computer or computer-based workstation 3 to the web front end 9. However, it will be understood that when the term “Internet” is used herein, other types of computer and communications networks are also contemplated and considered equivalent as noted above.

In one embodiment of the present invention, a user interface system 70 (described in detail below), stored on the web front end 9, generates browser views for display on the package sender's computer 3. The web front end 9 is coupled to an internal network 11 operated by the SSP, which is coupled to other computing functions, including the address hygiene function 30.

The address hygiene function 30 consists of any number of validation or standardization engines 33,35,37,39 which access validation or standardization databases 34,36,38,40. A particular hygiene engine 33,35,37, or 39 and its connected database represent an address hygiene system 42,43,44,45. In one embodiment of the present invention, the package sender 1 utilizes the claimed invention to select a particular address hygiene system, such as system 42, or any sequence of the address hygiene systems 42-45. In another embodiment, the claimed invention automatically interfaces a package processing system with one or more of the address hygiene systems 42-45.

### User Interface System Architecture

FIG. 3 shows further details of the web front end 9 of FIGS. 1 and 2. The user interface system 70 is stored on the web front end 9. In embodiments of the present invention, a method, process, or routine as described below for selecting an address hygiene system 42 can be performed through the user interface system main module 50 and the select address hygiene system module 65. In the embodiment of the invention shown in FIG. 3, the user interface system main module 50 and the select address hygiene system module 65 comprise the user interface system 70. As shown in FIG. 3, the user interface system 70 is linked to the address hygiene function 30 through an internal network 11, such as a LAN.

### System Operation

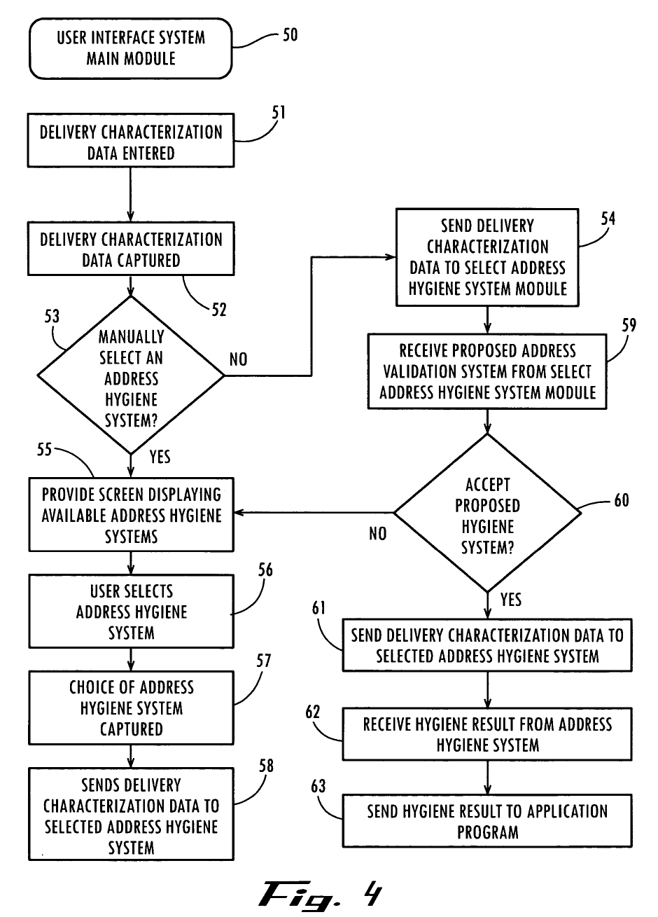

With the foregoing description in mind, turn now to FIG. 4 for a discussion of the various computer-implemented processes for carrying out the preferred embodiments of the present invention. Although the preferred embodiments are generally described with reference to an Internet accessible personal computer (PC) operated by a customer or package sender and a Internet web site operated by a SSP, the present invention can also be implemented in conjunction with other program modules for other types of computers and networks.

Furthermore, those skilled in the art will recognize that the present invention is may be implemented in a distributed or networked computing environment such as the Internet. In a distributed or networked computing environment like the Internet, program modules may be physically located in different local and remote memory storage devices. Execution of the program modules may occur locally in a stand-alone manner or remotely in a client/server manner. By way of illustration and not limitation, distributed computing environments include local area networks (LAN) of an office, enterprise-wide area networks (WAN), and the global Internet (wired or wireless connections). Accordingly, it will be understood that the terms computer, operating system, and application program include all types of computers and the program modules designed to be implemented by the computers. Also, the user interface system 70 and the address hygiene function 30 can be program modules running on a single computer.

The following discussion of methods is represented largely in terms of processes and operations by conventional computer components, including a central processing unit (CPU), memory storage devices for the CPU, connected display devices, and input devices. Furthermore, these processes and operations may utilize conventional computer components in a heterogeneous distributed computing environment, including remote file servers, remote computer servers, and remote memory storage devices. Each of these conventional distributed computing components is accessible by the CPU via a communication network.

The processes and operations performed by the computer include the manipulation of signals by a CPU, or remote server such as an Internet web site, and the maintenance of these signals within data structures reside in one or more of the local or remote memory storage devices. Such data structures impose a physical organization upon the collection of data stored within a memory storage device and represent specific electrical or magnetic elements. These processes are the means used by those skilled in the art of computer programming and computer construction to most effectively convey teachings and discoveries to others skilled in the art.

For the purposes of this discussion, a process, method, or routine is understood to include a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, bytes, words, values, elements, symbols, characters, terms, numbers, points, records, objects, images, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, positioning, placing, and altering which are often associated with manual operations performed by a human operator. The operations described herein also include machine operations performed in conjunction with various input provided by a human operator or user that interacts with the computer.

In addition, it will be understood that the programs, processes, routines and methods described herein are not related or limited to any particular computer or apparatus, nor are they related or limited to any particular communication network architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

As described above, the user interface system 70 can consist of a user interface system main module 50 and a select address hygiene system module 65. The package sender 1 accesses the user interface system 70 through the Internet 7 for the purpose of validating an address, among other things.

With the foregoing in mind, FIG. 4 is a flow chart describing operation of the user interface system main module (“UISMM”) 50, as shown in FIG. 3, which the package sender 1 or the ISS 10 executes in order to select one or more of the address hygiene systems 42-45 for use in validating an address. In one embodiment of the invention, address validation systems may reside in the address hygiene function 30, while in another embodiment of the present invention, address standardization systems may reside in the address hygiene function 30. The same routines, processes, and modules can be utilized to select one or more address standardization systems for use in standardizing an address, or one or more address validation systems, or a combination of validation and standardization systems.

FIG. 4 illustrates these functions in a typical order of execution. The functions or processes in this figure are carried out in the disclosed embodiment of the present invention by software executing on the ISS 10, located on the web front end 9, in conjunction with a browser computer program executing on a package sender's computer 3, when each are connected to the Internet 7 and in communication with each other.

FIG. 4 illustrates a preferred routine implemented by the user interface system 70. The preferred routine has been labeled the user interface system main module 50 for illustrative purposes only. It should be understood that the name is generic and merely used to describe a process, method, or routine having particular functions. Upon access to the user interface system main module (UISMM) 50, the package sender 1 enters delivery characterization data Step 51, for the purpose of having a package delivered. In another embodiment of the present invention, the delivery characterization data can be entered via an optical barcode scanner, a scanner for two-dimensional or other symbols, a scanner for radio frequency identification (RFID) tags, or other reader equipment performing similar functions. Delivery characterization data can include, but is not limited to, information such as the street number, street name, city, state, postal code, extended postal code, type of package, name of carrier, and P.O. Box number. The USIMM 50 then captures the entered delivery characterization data at Step 52 in a conventional memory device.

At Decision Step 53, the user decides whether to manually select an address hygiene system to use in validating an address. If the user decides to manually select an address hygiene system, the USIMM 50 has the capability to provide a screen (Step 55) displaying on a menu an indication of the available address hygiene systems 42-45. Step 56 represents the user selecting a particular address hygiene system 42 from the plurality of available address hygiene systems displayed at Step 55. The user's selection is then captured by the USIMM at Step 57. Once the selection is captured at Step 57, the UISMM sends the delivery characterization data associated with the sender's package to the selected address hygiene system or systems (Step 58).

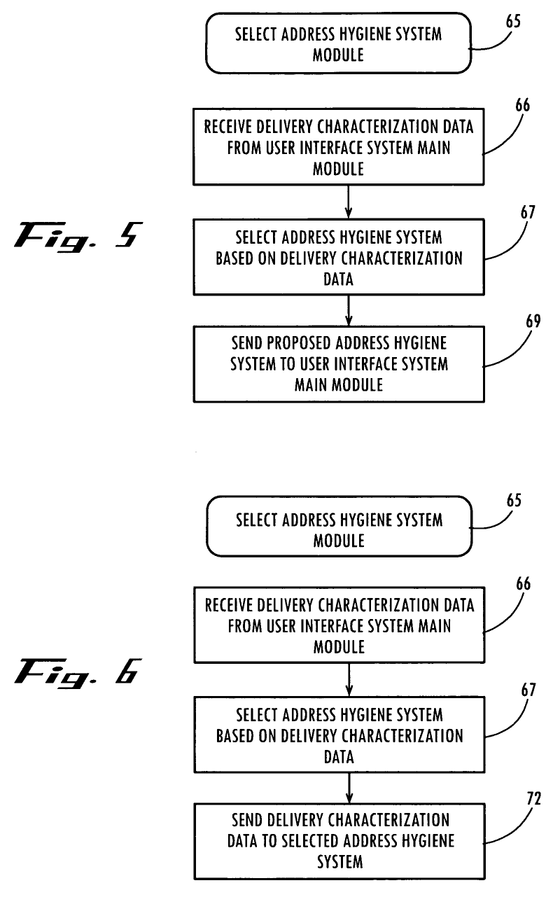

If the user does not want to manually select an address hygiene system at Decision Step 53, the USIMM 50 branches to Step 54 and sends the delivery characterization data to the select address hygiene system module (“SAVSM”) 65. FIG. 5 and FIG. 6, described in detail below, represent the process or routine performed by the SAVSM 65. Continuing with FIG. 4 at Step 59, the USIMM 50 receives and displays the data identifying the proposed address hygiene system from the SAVSM 65. At Decision Step 60, the user decides whether to use the proposed address hygiene system 42. If the user selects “no”, the process branches to Step 55 and the USIMM 50 provides a screen displaying an indication of the available address hygiene systems. From here, Steps 56,57, and 58 are repeated. Thus, the user selects an address hygiene system 42-45 from the plurality of address hygiene systems provided, the user's choice of address hygiene systems is captured by the UISMM 50, and the delivery characterization data is sent to the selected address hygiene system 42-45. If the user decides at Decision Step 60 to use the proposed address hygiene system 42-45, the USIMM 50 sends the delivery characterization data to the selected address hygiene system at Step 61.

At Step 62 the USIMM 50 receives address hygiene processing results from the selected address hygiene system 42-45. At Step 63, the USIMM 50 sends such results to an application program module such as the ISS 10. In the alternative, the address hygiene system 42-45 may send the processing results directly to the application program.

FIG. 5 illustrates the process carried out by the select address hygiene system module (SAVSM) 65. At Step 66, the SAVSM 65 receives the delivery characterization data from the UISMM 50. At Step 67, the SAVSM automatically selects an address hygiene system 42-45 based on the entered delivery characterization data. The selection by the SAVSM 65 would occur through the utilization of an algorithm based on selected delivery characterization data. For example, a carrier management system allows customers to obtain costs and other information to decide which carrier will deliver their packages. Part of the delivery characterization data could be the identification of a particular carrier. Therefore, during entry of the delivery characterization data, the user could designate a particular carrier to use in delivery of the package. The algorithm would then utilize a look-up table (not shown) to match a carrier with an appropriate address hygiene system or systems 42-45. The algorithm would pick the address hygiene system or systems 42-45 that best serve that carrier, or that are required by that carrier. After an address hygiene system has been selected, the SAVSM 65 sends the proposed address hygiene system 42 to the UISMM 50 at Step 69.

FIG. 6 illustrates another embodiment of the select address hygiene system module (SAVSM) 65. Under this embodiment, the SAVSM 65 does not send the proposed address hygiene system back to the UISMM 50 as at Step 69 of FIG. 5 for user approval. Instead, the SAVSM 65 receives delivery characterization data from the UISMM 50 at Step 66, selects an address hygiene system based on the delivery characterization data at Step 67, and sends the delivery characterization data directly to the selected address hygiene system at Step 72.

It will be understood that whenever data is transmitted from one computer component to another as described above, an appropriate memory device of the receiving computer component may be updated.

In light of the above, it should be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for interfacing a package processing system with an address hygiene system comprising;
a user interface system programmed to:
display a menu including indications of a plurality of address hygiene systems; and
receive input designating one or more of said address hygiene systems.

2. The system as claimed in claim 1, wherein said user interface system is further programmed to;
capture delivery characterization data; and
send said delivery characterization data to said designated address hygiene system or systems.

3. The system as claimed in claim 2, wherein said user interface system is further programmed to;
receive hygiene information back from said one or more address hygiene systems.

4. The system as claimed in claim 2, wherein said address hygiene systems are located on one or more remote computer systems.

5. The system as claimed in claim 2, wherein said address hygiene systems are address validation systems.

6. The system as claimed in claim 2, wherein said address hygiene systems are address standardization systems.

7. The system as claimed in claim 2, wherein said interface system is programmed to capture said delivery characterization data from a user data entry device.

8. The system as claimed in claim 2, wherein said interface system is programmed to capture said delivery characterization data from a scanning device.

9. A system for interfacing a package processing system with one of a plurality of address hygiene systems comprising;
a user interface system programmed to:
capture delivery characterization data associated with a package; and
automatically select one or more address hygiene systems from a plurality of address hygiene systems based upon said delivery characterization data.

10. The system as claimed in claim 9, wherein said user interface system is further programmed to;
send said delivery characterization data to said one or more selected address hygiene systems; and receive hygiene information from said address hygiene systems.

11. The system as claimed in claim 10, wherein said interface system is further programmed to;
display an indication of said one or more selected address hygiene systems; and
accept input from a user approving or disapproving said one or more selected address hygiene systems.

12. The system as claimed in claim 11, wherein said interface system is further programmed to;
send said delivery characterization data to said selected address validation system in response to said user input approving said one or more selected address validation systems.

13. The system as claimed in claim 11, wherein said interface system is further programmed to;
display a menu of indications of available address validation systems in response to said user input approving said one or more selected address validation systems;
receive designation user input data designating one or more address hygiene systems from said display; and
send said delivery characterization data to said designated address hygiene systems.

14. A method for interfacing a package processing system with one of a plurality of address hygiene systems comprising;
displaying a menu of indications of address hygiene systems to a user via a user interface; and
receiving input designating one or more of said address hygiene systems from said menu.

15. A method as claimed in claim 14, further comprising:
receiving delivery characterization data entered via said user interface;
sending said delivery characterization data to said designated one or more address hygiene systems; and
receiving address validation information from said address hygiene system.

16. A method for interfacing a package processing system with one of a plurality of address hygiene systems comprising;
receiving delivery characterization data via an interface; and
selecting one or more address hygiene systems from a plurality of address hygiene systems based upon said delivery characterization data.

17. The method as claimed in claim 16, further comprising,
sending said delivery characterization data to said selected address hygiene system; and receiving validation information back from said selected address hygiene system.
